(19) United States
(12) Patent Application Publication
(10) Pub. No.: US 2006/0155570 A1
(43) Pub. Date: Jul. 13, 2006

(54) Aggregation and control of documents in the document repository using meta data and context information and creation of online info binder

(76) Inventors: Jess Almeida, Pleasanton, CA (US); Kamlesh Amin, San Jose, CA (US); Severo D'Souza, San Jose, CA (US); Cyril Mecwan, Saratoga, CA (US); Koustubh Naik, Pune (IN); Anoop Tewari, San Jose, CA (US)

Correspondence Address: Tue Nguyen, 496 Olive Ave., Fremont, CA, 94539, US

(21) Appl. No.: 11/328,939

(22) Filed: Jan. 10, 2006

Related U.S. Application Data
(60) Provisional application No. 60/643,451, filed on Jan. 13, 2005.

(51) Int. Cl. G06Q 99/00

(52) U.S. Cl. 705/1

(57) ABSTRACT

The present invention discloses a method and system for electronically aggregating and controlling of documents in a real estate transaction by the assignment of various meta-attributes to the documents when they are uploaded to the system. Based on the attributes, the documents are put into folders having the same attribute-associated characteristics, and from then, the system can aggregate the documents as classified by the attributes. The attributes can be assigned manually to the documents by the persons uploading the ducuments, can be assigned automatically with the same attribute of the folder to be uploaded to, or can be assigned automatically based on a default attribute list in which all documents in a real estate transaction are assigned a default attribute.

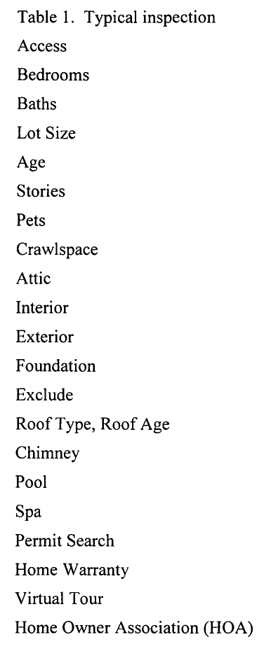

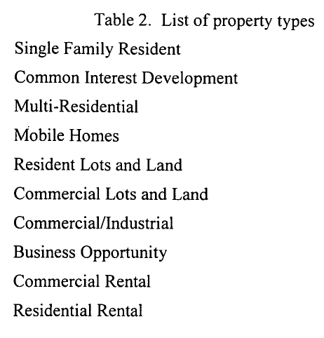

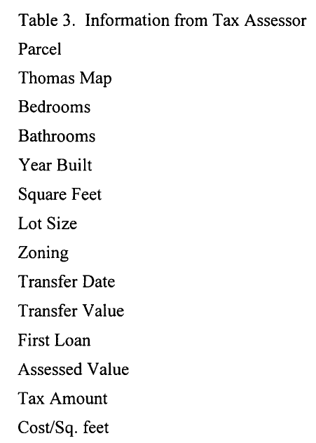

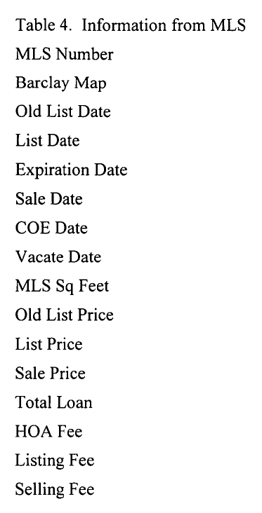

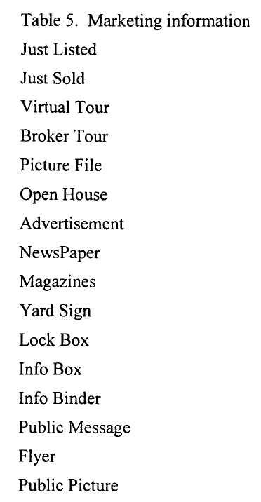

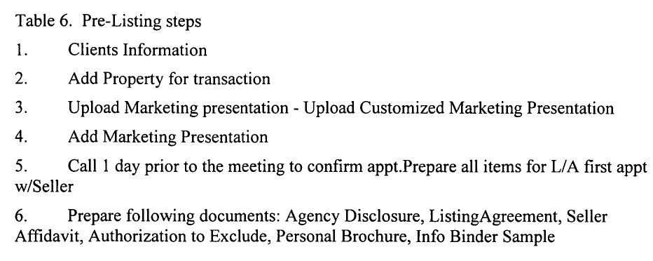

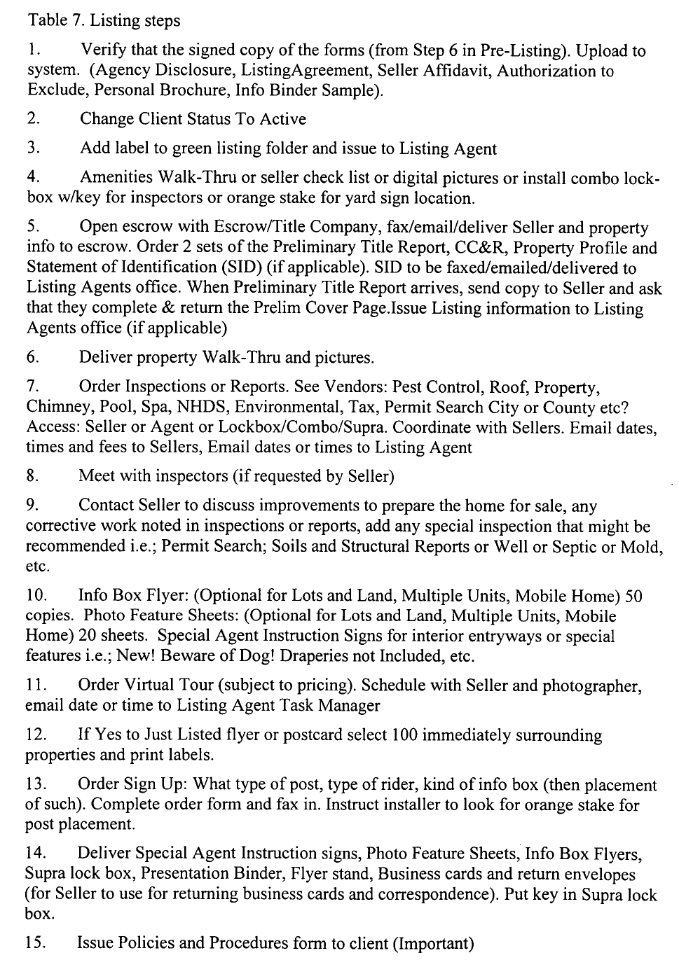

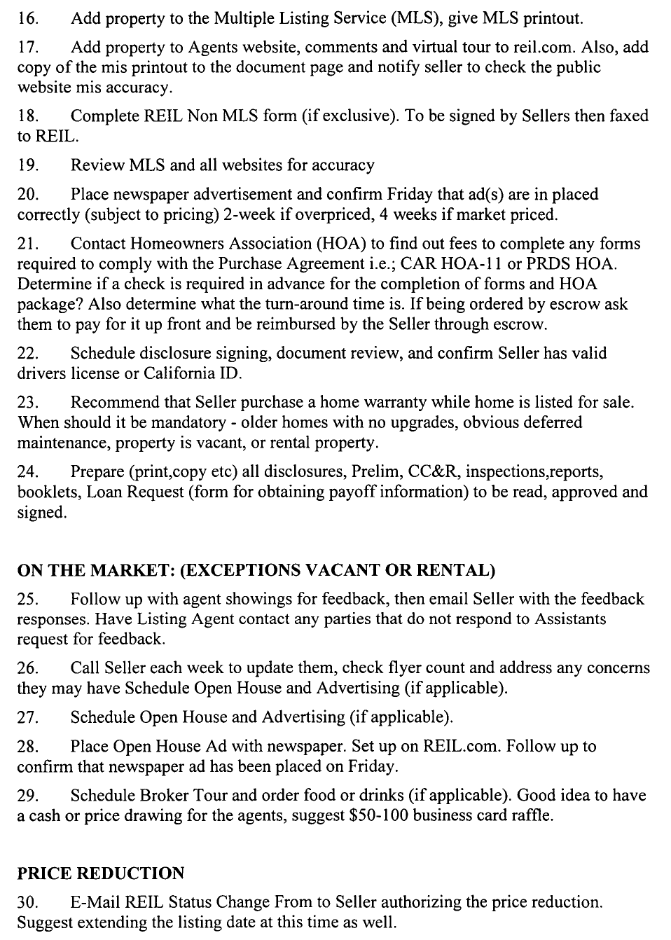

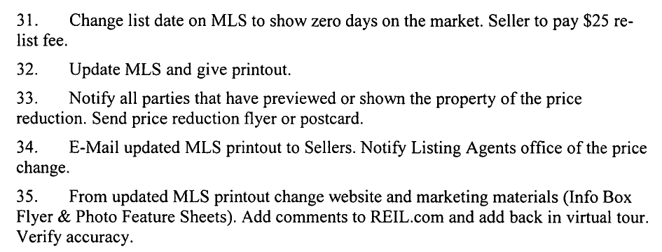

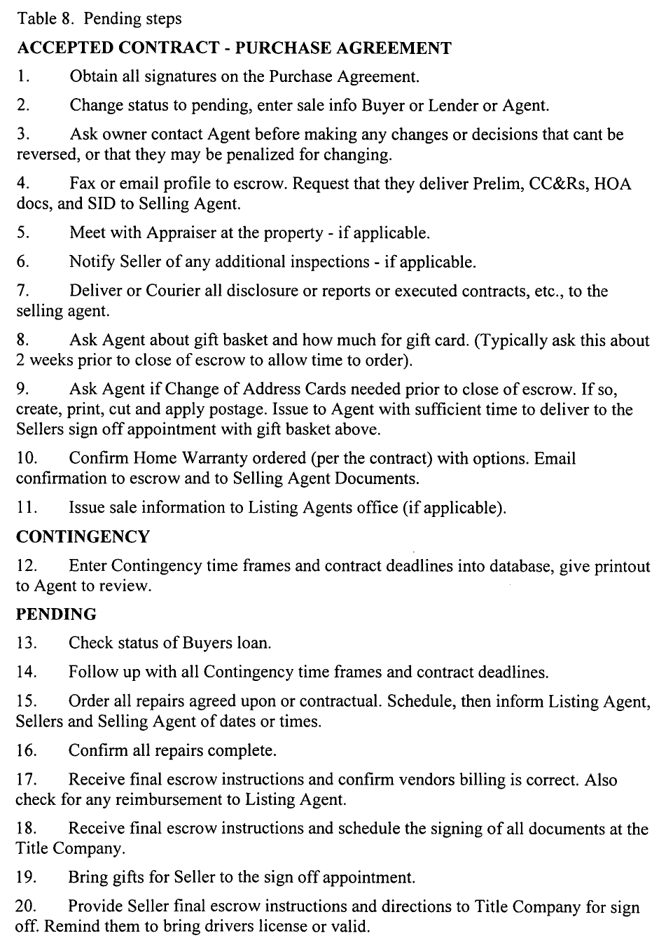

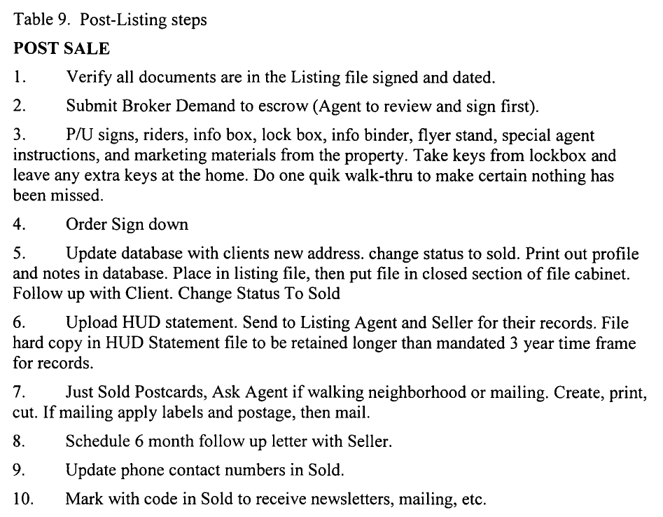

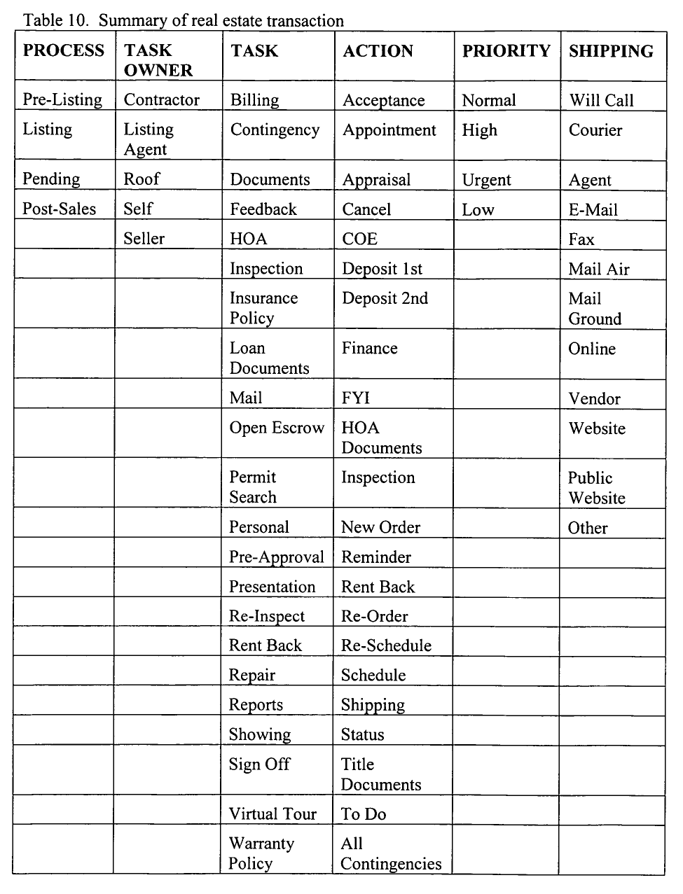

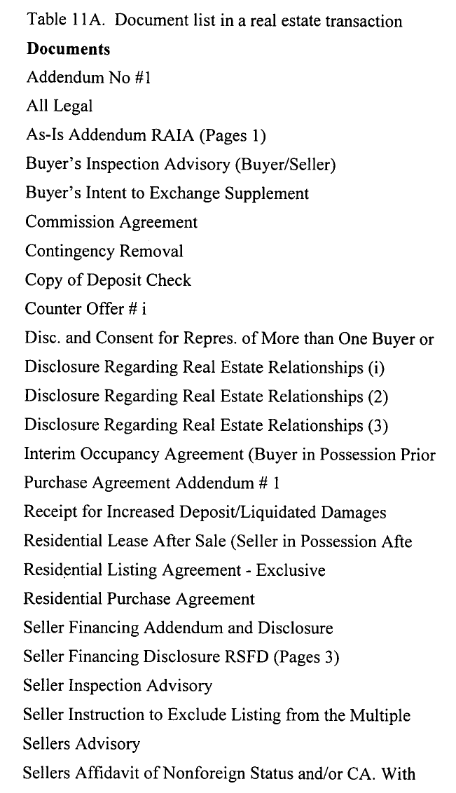

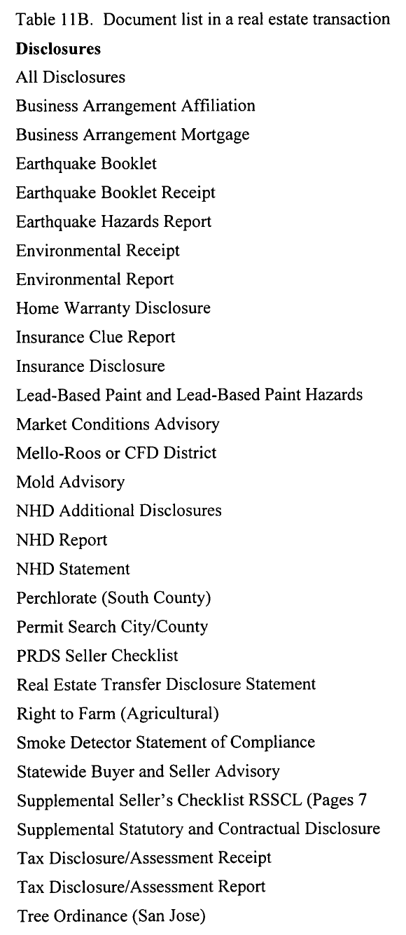

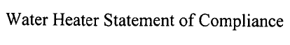

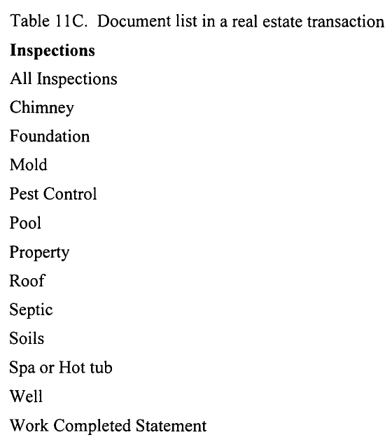

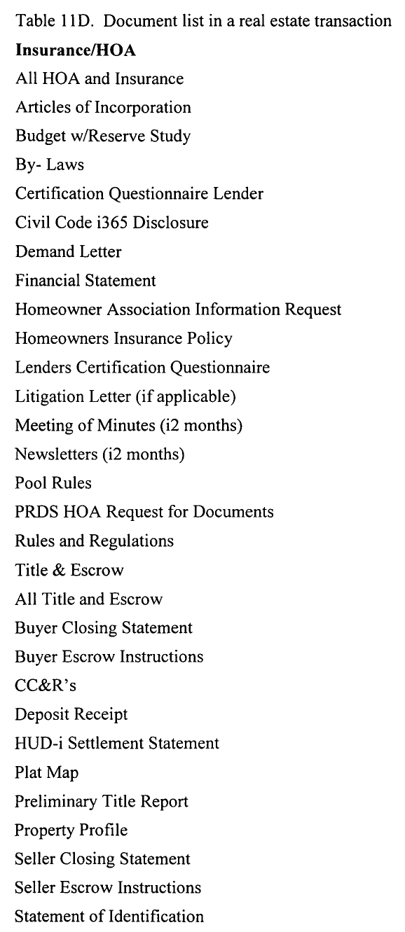

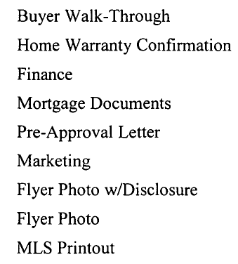

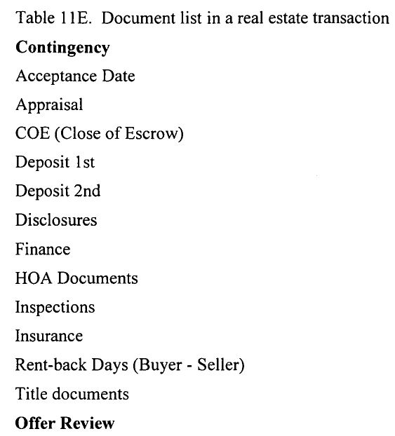

This application claims priority from U.S. provisional applications Ser. No. 60/643,451 filed Jan. 13, 2005, entitled “Aggregation and Control of Documents in the Document Repository using Meta Data and Context Information and creation of Online Info Binder” which is incorporated herein by reference.

### FIELD OF THE INVENTION

This application is related to a real estate transaction, and particularly to a simplified and effective method and system to perform real estate services.

### BACKGROUND OF THE INVENTION

Every real estate transaction involves the creation and exchanges of multiple documents between multiple parties, including buyer, seller, their respective agents, brokers, and agencies and various service providers such as financial institutions (e.g., mortgage lenders and underwriters), escrow companies, title companies, insurance companies, construction companies, advertising companies, architects, property inspectors, appraisers, attorneys, property managers, aerial photographers, property photographers, governmental agencies (e.g., county clerk, deed recording).

Thus the aggregation and control of document repository in a real estate transaction are critical due, at least in part, to the number of participants in a transaction and the numerous documents involved, ranging from information disclosure to many needed work completions, and to the constant exchanged, revised and updated actions between multiple parties. Currently, it is difficult for the parties to view the contents of the various transaction documents on demand. Even more difficult is the need to preserving confidentiality of certain documents.

### SUMMARY OF THE INVENTION

The present invention discloses a method and system for electronically aggregating and controlling of documents in a real estate transaction by the assignment of various meta-attributes to the documents when they are uploaded to the system. Based on the attributes, the documents are put into folders having the same attribute-associated characteristics, and from then, the system can aggregate the documents as classified by the attributes. The attributes can be assigned manually to the documents by the persons uploading the documents, can be assigned automatically with the same attribute of the folder to be uploaded to, or can be assigned automatically based on a default attribute list in which all documents in a real estate transaction are assigned a default attribute. The attribute of a document can be updated when needed, or when the document is updated. A document can have a plurality of attributes, and thus can be assigned to more than one folder. The folders can have different security levels, based on the assigned attributes.

The electronic folders can be a buyer folder, a seller folder, a public folder, a company folder, a buyer agent folder, a buyer broker folder, a seller agent folder, a seller broker folder, a title company folder, a escrow company folder, a servicing company folder, and a lender company folder. The electronic folder can be an info-binder folder, where all the documents in this folder contain all the public documents for an advertisement of the property listed.

### BRIEF DESCRIPTIONS OF THE DRAWINGS

Table 1. Typical inspection and billing.

Table 2. List of property types.

Table 3. Information from Tax Assessor.

Table 4. Information from MLS.

Table 5. Marketing information.

Table 6. Pre-Listing steps.

Table 7. Listing steps.

Table 8. Pending steps

Table 9. Post-Listing steps

Table 10. Summary of real estate transaction

Table 11A. Document list in a real estate transaction—Documents

Table 11B. Document list in a real estate transaction—Disclosures

Table 11C. Document list in a real estate transaction—Inspections

Table 11D. Document list in a real estate transaction—Insurance

Table 11E. Document list in a real estate transaction—Contingency and Offer review

### DETAILED DESCRIPTION OF THE INVENTION

Table 1 lists a typical overview inspection area for a real estate transaction according to the present invention. This list can serve as a template for checklist, to ensure the completeness of the inspection.

Table 2 lists the property types in a typical real estate transaction. The present invention allows for the branching of decisions based on property type. The input of the property type can be manually entered, or can be automatically received from Tax Assessor record, or from MLS record.

Table 3 and 4 list the information that a Tax Assessor or a MLS (Multiple Listing Service) can provide. This information can be used for decision branching in the present invention.

Table 5 lists the information needed for marketing a real estate property.

Table 6 lists the steps according to the present invention prior to the listing of a property. Table 7 list the steps according to the present invention for the listing of a property, following the pre-listing steps. The listing steps further includes the steps for putting the property on the market, and the optional steps of reduction in price. Table 8 lists the steps for a pending action, after receiving an offer. Pending steps includes the steps of review the offer, steps for contingency action, and the pending actions. Table 9 lists the steps for the Post-Listing, after selling the property.

Table 10 lists a summary of the real estate transaction, including the processes, the task owners, the tasks, the actions, the priority and the shipping actions.

Tables 11A-E list the documents in a real estate transaction, in which Table 11A lists the documents, Table 11B lists the disclosures, Table 11C lists the inspection documents, Table 11D lists the Insurance and Home Owner Association (HOA) documents, and Table 11E lists the contingency documents and offer review document.

The present invention discloses a method and system for electronically aggregating and controlling of documents in a real estate transaction by the assignment of various attributes to the documents when they are uploaded to the system. The attributes may be assigned by the person uploading the document or may be automatically assigned based on location where the document is being uploaded, i.e. inheriting attributes from the context information. Further, since real estate transaction involves many predetermined forms, the attributes may be readily assigned to certain documents in a default attribute list. Each document then has this meta-data attribute available in a database. This meta-data is updated when the document is updated or amended and purged when the document is deleted.

In an embodiment of the present invention, the system comprises an electronic-formatted master real estate transaction document folder. The master document folder is organized into many classification subfolders with each subfolder being associated with a meta-data attribute. The basic classification subfolders include, but not limited to:

seller subfolder associated with seller meta-data attribute,

seller agent subfolder associated with seller agent meta-data attribute,

seller broker subfolder associated with seller broker meta-data attribute,

buyer subfolder associated with buyer meta-data attribute,

buyer agent subfolder associated with buyer agent meta-data attribute,

buyer broker subfolder associated with buyer broker meta-data attribute,

public subfolder associated with public meta-data attribute,

title company subfolder associated with title company meta-data attribute,

escrow company subfolder associated with escrow company meta-data attribute,

servicing company subfolder associated with servicing company meta-data attribute,

lender company subfolder associated with lender company meta-data attribute, and

info-binder subfolder associated with info-binder meta-data attribute.

The various documents in real estate transaction are then uploaded to the master document folder when available. There are three ways of assigning the document to the proper subfolder.

The first is for the person who uploads the document to the master document folder to assign a plurality of meta-data attributes to the document, and then the computer system automatically puts the document into the subfolders associated with these meta-data attributes. For example, pictures taken from a property walkthrough can be assigned the meta-data attribute of public. Thus when uploading, these pictures will be automatically put into the public subfolder, which is the subfolder having the associated public meta-data attribute.

The second is for the uploading person to put the document into the desired subfolders. Then the computer system automatically assigns the meta-data attributes associated with those subfolders to the document. For example, the document of property disclosure can be uploaded directly to the public folder without any assignment of attribute. The document will then be assigned a public meta-data attribute.

The third is for the system to have a default meta-data attribute list. In this list, there are a list of documents and their default associated meta-data attribute. By uploading a document into the master document folder without a meta-data attribute, the default meta-data attribute list is consulted, and the document is put into the subfolder associated with its default meta-data attribute subfolder. For example, the default meta-data attribute list can include the documents of pictures taken from a property walkthrough and property disclosure to be of public meta-data attribute. Thus these documents can be uploaded directly to the public subfolder and a public meta-data attribute is assigned to these documents.

Thus a document can be marked public by virtue of explicit request from the creator, by simply uploading in public area, or by default being a public document.

A document might have more than one meta-data attribute, and thus is available in more than one subfolder. For example, a document might have both seller and listing agent (seller agent) attribute, and will be available in both seller and listing agent subfolders.

The subfolders can be consolidated. For example, all subfolders related with seller, seller subfolder, seller agent subfolder and seller broker subfolder, can be consolidated to a seller subfolder. The subfolder can further sub-divided. For example, the servicing company subfolder can include appraisal service, home repair service, landscaping service, home inspection service, etc. In a basic embodiment, there are three subfolders of buyer, seller and public.

The use of meta-data attribute associated with the documents and the subfolders allows the system to catalog the documents and to maintain security. Since all these documents may be viewed online, the system can enforce access rights based on user credentials. For example, any user who can access the online system will automatically be allowed to view the document in the public subfolder. A document having only listing agent (i.e. seller agent) and seller attributes may be shared only between the listing agent and seller. This document will be restricted and may not be available, either not displayed in the list of available documents, or displayed but marked so that it cannot be selected, unless the user logs in with the credential of the listing agent or seller.

The master document can automatically select the documents for the creation of Online Info-Binder, which may be displayed online, or printed to create a traditional hardcopy binder for display at the property. The Online Info Binder normally contains all the documents in the public folder since it is used for public knowledge. Another way for the document to get into the Online Info Binder is to contain the Info-Binder attribute, which then will automatically make its way to the Info-Binder catalog of documents and will also become available to buyer and his/her agent. A property disclosure, for example, would be a candidate for the Info-Binder. Pictures taken during walkthrough would inherit attributes that would make the uploaded pictures available for Info-Binder and also for Design Center where it is used by agent and broker for a post sale marketing and lead generation activity.

As the documents accumulate, the master document, and the Info-Binder “draft” copy can be updated with newly arrived documents. User may “publish” the Info-Binder as is or further edit it, for example, explicitly add more documents or delete any document. Once published, the Info-Binder is available to all the users of the system just like a traditional Info-Binder is made available to prospective buyers and their agents.

The system is capable of accepting document in all electronic formats. Conversion to electronic format can also be accepted, for example, a signature digitizer pad or electronic signature pen to translate a user's signature into a digital image or file, paper documentation can be scanned, using a standard electronic document-scanning device. If the documents marked to be used in the Info-Binder are in portable format then they may be combined to create one large user friendly and indexed catalog which may be browsed online. If the documents are in disparate format and cannot be ported to unified formats, then they are cataloged in an online directory with appropriate indexing.

The present invention is directed to a system that satisfies the need for a real estate transaction management system which completely integrates all documents with proper access rights. In a preferred embodiment, the system comprises a server, executing software stored in a hard drive and thereby provides a plurality of folders within the real estate transaction management system. The folders can be accessed using the remote computers connected to the server via the Internet. The folders include agent folder, buyer folder, seller folder, service provider folder, etc. The term folders as used herein refer to the collections of documents and information designed for a particular user of the real estate transaction management system. Each folder allows a respective party to a real estate transaction to selectively access information relevant to that party.

Participants or potential participants in a real estate transaction can access, generate, and modify real estate-related documents, information, and reports through a the real estate transaction management system. Parties to the transaction can also track the development since the system contains up-to-date information on the real estate transaction. And access to the particular documents can also be restricted to certain party based on access rights. Each party using the real estate transaction system is provided with a username and password upon registering to use the system. The username and password can be permanent, e.g. for the life of the transaction, or only temporary, e.g. valid only for a few days. After obtaining a username and password, the party may log on to the system anywhere using a remote computer.

The present invention facilitates the isolation of data by the assignment of meta-data attributes. The system allows general documents to be generally accessed while limiting the accessibility of certain documents to the intended party. The system further allows third parties to access the documents when authorized, for example, by obtaining a user name and password.

One embodiment of the method of the invention provided for aggregation and control of document repository is to assign a document to an electronic-formatted master real estate transaction document folder with the master document folder comprising a plurality of classification subfolders and each classification subfolder being associated with a meta-data attribute. The method comprises the steps of either assigning a meta-data attribute to the document; and then uploading the document to the master document folder wherein the document is automatically put into a classification subfolder based on the meta-data attribute; or uploading the document to a classification subfolder; and then automatically assigning a meta-data attribute associated with the classification subfolder to the document.

The master folder may have a default meta-data attribute list of default meta-data attribute for a predetermined group of documents, and in that case, the method also include the steps of uploading the document to the master document folder; then consulting the default meta-data attribute list for assigning a meta-data attribute to the document; and putting the document into a classification subfolder based on the meta-data attribute.

Real estate transaction settlement papers are mostly in predetermined forms, such as HUD-1 settlement sheet, Note, Deed, Deed of Trust (known also as Mortgage), Right of Rescission for a refinance, and all ancillary documents related to a real estate settlement, such as Addendum Page To HUD-1, Contract/Correction Agreement, Limited Power Of Attorney, Owners Affidavit, Survey Affidavit, Compliance Agreement, Owner/Seller Affidavit, Escrow Agreement, Affidavit For Acknowledgment Of Re-Recording, Attorney Representation Letter, Borrower/Seller/Settlement Agent Funding Policy Affidavit, Borrower Certificate/Affidavit, Buydown Agreement, Compliance Agreement, Disclosure Statement, Escrow Waiver Agreement, FHA Firm Commitment, Final Signed 1003 Application, First Lien Title Clearance Letter, First Payment Letter, Flood Hazard Notice, GNMA Refinance Certification, HUD-1 Borrower/Seller/Agent Certification, Initial HUD-1 Escrow Statement, IRS Form 4506, IRS Form 8821, IRS Form W-9 For All Borrowers, Itemization Of Amount Financed, Deed Of Trust Rider(S), Name Affidavits For All Borrowers, Notice Of Assignment Of Servicing Notice Of Right To Cancel Notice To Homeowner, Notice To Mortgagor Relating To Prepayment, Tax Information Sheet, Truth-In-Lending Statement, VA 26-1820, VA Collection Policy Notice, Warranty Of Completion, Consolidated Note, Original Note, Mortgagor's Affidavit, Title Insurance, Survey, FHA HD-1 Addendum, PMI Disclosure, Tax Escrow Designation, Tax Information Sheet And Net Funding Sheet, Authorization And Disbursement, Initial Escrow/Impound-Aggregate Disclosure, Repair Escrow Agreement, W-9's, Notice Of Right To Cancel, Final Truth-In-Lending, Certification Of Occupancy, Monthly Payment Acknowledgement, Occupancy Affidavit, 1040 Form/4506 Form, Smoke Alarm Affidavit, Property Insurance Account Disclosure, Notice To Homeowner, Fraud Notice, Borrower Notification, Criminal Code 1010, VA Disbursement Certificate, Verification Of VA Benefit Form 26-8937, Veterans And Lender Statement, Undertaking And Indemnity, Original Security Agreement, Original Recognition Agreement, Original Property Lease/Occupancy Agreement, Stack Shares Or Membership Certificate Evidencing Ownership, Original Executed Copy Of UCC-1 Financing Statement, UCC-1 Filing Authentication Agreement, Original Executed Copy Of UCC-3, Original Stock Power, Original Assignment Of Property Leas, Restricted Occupancy Certificate, Co-Op Board Supplement, Co-Op Loan Collateral Receipt, Letter Agreement, Affidavit Of Purchaser, Affidavit Of Seller, First Lien Registration Certificate, Corp. Maintenance/Assessment Letter, Good Faith Estimate, Rate Lock-In, Commitment Letter/Addendum, Advance Disclosure Statement, Broker Letter And Copy Of Check, Escrow Waiver, State Required Disclosures, Funding/Wiring Instructions, Name Affidavit, Specific Power Of Attorney, Assignment Of Security Instrument, Security Instrument, Loan Modification Agreement, Tax Information Sheet Signed By Closing Agent, Tax Authorization Letter, Title Binder/Policy, Final Typed Loan Application, Servicing Transfer Disclosure, Adjustable Rate Mortgage Disclosure, Verification Of Deposit Gift Letter, Affordable Housing Mortgage Credit Certificate Worksheet, Affordable Housing Mortgage Credit Certificate, W-4 IRS Worksheet, Sales Contract, Good Faith Estimate, W-9 For Primary Borrower, Telephone Employment Conformation Form. These documents can all be assigned a default attribute based on their creator or their subject.

The method may further includes the step of creating an empty master document folder; identifying a document to be included in the master document folder; and then uploading the document into the master folder.

In the present invention, the meta-data attribute can be updated when the document is updated. The meta-data attribute of the classification folders can be seller attribute, seller agent attribute, seller broker attribute, buyer attribute, buyer agent attribute, buyer broker attribute, public attribute, agency attribute, title company attribute, lender attribute, servicing company attribute, or escrow company attribute. The classification folders can comprise at least a folder having a public meta-data attribute, a folder having a seller meta-data attribute, a folder having a buyer meta-data attribute. The document can have more than one meta-data attributes and can be available in the associated classification folders. The system can include a table of plurality of access rights associated with the meta-data attributes whereby each access right is associated with a plurality of meta-data attributes.

What is claimed is:

1. A method for electronically aggregating and controlling of documents in a real estate transaction, the method comprising
assigning a plurality of meta-attributes to the documents;
uploading the documents with the meta-attributes to attribute-associated electronic folders; and
electronically aggregating the documents according to the meta-attributes.

2. A method as in claim 1 wherein the meta-attributes are assigned manually by the person uploading the documents.

3. A method as in claim 1 wherein the meta-attributes are assigned automatically based on the folder to be uploaded.

4. A method as in claim 1 wherein the meta-attributes are assigned automatically based on a default attribute list.

5. A method as in claim 1 further comprising a step of updating the meta-attributes when the documents are updated.

6. A method as in claim 1 wherein the electronic folders are selected from a list of a buyer folder, a seller folder, a public folder, a company folder, a buyer agent folder, a buyer broker folder, a seller agent folder, a seller broker folder, a title company folder, a escrow company folder, a servicing company folder, and a lender company folder.

7. A method as in claim 1 wherein a document has a plurality of meta-attributes and uploaded to a plurality of attribute-associated electronic folders.

8. A method as in claim 1 wherein the attribute-associated folders have different security levels to limit the access of the documents to an intended party.

9. A method as in claim 1 wherein the electronic folders comprises an info-binder folder.

10. A method as in claim 9 further comprising a creation of an info-binder,
wherein the info-binder contains all documents from the info-binder folder; and
wherein the info-binder contains an advertisement of a property to be listed.

11. A method for electronically aggregating and controlling of documents in a real estate transaction, the method comprising
providing a plurality of electronic folders;
providing a meta-attribute to each electronic folder;
uploading a document to an electronic folder, while automatically assigning the meta-attribute of the electronic folder to the document; and
electronically aggregating the documents according to the meta-attributes.

12. A method as in claim 1 further comprising a step of updating the meta-attributes when the documents are updated.

13. A method as in claim 1 wherein the electronic folders are selected from a list of a buyer folder, a seller folder, a public folder, a company folder, a buyer agent folder, a buyer broker folder, a seller agent folder, a seller broker folder, a title company folder, a escrow company folder, a servicing company folder, and a lender company folder.

14. A method as in claim 1 wherein a document has a plurality of meta-attributes and uploaded to a plurality of attribute-associated folders.

15. A method as in claim 1 wherein the attribute-associated folders have different security levels to limit the access of the documents to an intended party.

16. A method for electronically aggregating and controlling of documents in a real estate transaction, the method comprising
providing a plurality of electronic folders;
providing a meta-attribute to each electronic folder;
providing a default attribute list of meta-attribute, the default list comprising a list of default meta-attributes to a document in the real estate transaction;
uploading a document to an attribute-associated electronic folder, the attribute-associated electronic folder selected by associating the attribute of the electronic folder with the attribute of the document, the attribute of the document being obtained from the default attribute list; and
electronically aggregating the documents according to the meta-attributes.

17. A method as in claim 1 further comprising a step of updating the meta-attributes when the documents are updated.

18. A method as in claim 1 wherein the electronic folders are selected from a list of a buyer folder, a seller folder, a public folder, a company folder, a buyer agent folder, a buyer broker folder, a seller agent folder, a seller broker folder, a title company folder, a escrow company folder, a servicing company folder, and a lender company folder.

19. A method as in claim 1 wherein a document has a plurality of meta-attributes and uploaded to a plurality of attribute-associated folders.

20. A method as in claim 1 wherein the attribute-associated folders have different security levels to limit the access of the documents to an intended party.
